(19) United States
(12) Patent Application Publication
(10) Pub. No.: US 2004/0193313 A1
(43) Pub. Date: Sep. 30, 2004

(54) Kiosk system

(76) Inventors: Benoit Cornet, Chastres (BE); Xavier Marichal, St. Etienne (BE); Alok Nandi, Bruxelles (BE)

Correspondence Address: Daniel E. Fisher, DORSEY & WHITNEY LLP, Intellectual Property Department, 1001 Pennsylvania Avenue, NW, Suite 400 South, Washington, DE, 20004-2533, US

(21) Appl. No.: 10/755,673

(22) Filed: Jan. 13, 2004

Related U.S. Application Data
(60) Provisional application No. 60/439,809, filed on Jan. 14, 2003.

(51) Int. Cl. G06F 17/00

(52) U.S. Cl. 700/231

(57) ABSTRACT

A kiosk device comprises a plurality of input devices for acquiring a plurality of input signals; a memory device for storing a set of contents; a memory device for storing a plurality of rules, said rules linking input conditions and events to said set of contents; a processor device for treating said input signals and detecting conditions prevailing and events occurring in the environment of said kiosk device, and for determining from said conditions and events and on the basis of said set of rules, the contents to be provided, and a plurality of output devices for providing said contents.

### BACKGROUND

1. Technical Field

The invention relates to the field of kiosk systems for providing information to the public, and, more particularly, to a device and method for adapting the information provided to expectations of the public and other conditions.

2. Description of Related Art

Typically, kiosks are installed in public locations such as museums, shopping malls, points of sale, trade fairs, airports, etc. where the public is gathered or passes by. Information is provided to the public trough a display, which is usually a large size display, and a set of speakers. The various types of information that may be expected by the public may be very wide, ranging from availability of resources such as parking lot spaces, flight arrival and departure times, commercial proposals, product advertising, movie excerpts, etc.

It is therefore desirable that the information displayed be adapted to various conditions, including wishes and/or behaviors of the individuals in the public, groups of individuals, or the public as a whole, environment parameters such as date and time, weather conditions and outside events. There are however fundamental differences between the well-known interface between a computer (known as “personal” computer) and a single user, through a keyboard, mouse and other input devices, and the interface between a kiosk system and a group of individuals. In the single user computer paradigm, there is a strong interaction between the user and the computer, in which the attention of the user is dedicated to the computer, and where the user is knowledgeable in the use of the available input device, and expresses there through his/her wishes as to what the computer is expected to do. In the kiosk paradigm, there is a much weaker interaction between the group of individuals and the kiosk. It is not necessary that a single user be in command of what is to be displayed.

Prior Art Discussion.

Many kiosk devices are known. U.S. Pat. No. 4,974,170 discloses a simple kiosk having a display, and a set of input keys. By pressing a key, a user activates the display on a map of the locations of subscribers in the neighborhood, e.g. all pharmacies. This type of devices addresses the needs of a single user, and is closer to the single user computer paradigm, with a simple input device.

U.S. Pat. No. 6,163,822 discloses a kiosk system having a richer set of input devices, including a camera for detecting the presence or absence of a human, and a touch screen. This document addresses the problem of efficiently processing the various input commands given by the user for controlling the kiosk presentation, in an interactive dialog between the user and the kiosk system.

U.S. Pat. No. 6,434,271 discloses a technique for locating objects within an image. This technique aims at detecting a person or a group of persons in a sequence of digital images organized as array of pixels. The very crude algorithm for detecting persons, and disambiguating groups of persons relies on size, location and aspect ratio in a multi-user computer interface.

Availability and capabilities of image capture devices and processing power has increased sharply in the recent years, and prices also have decreased. The public is now expecting intelligent and fast response from kiosk systems, as well as a more intuitive and natural interaction. No known kiosk system currently addresses these needs.

There is therefore a need for a kiosk system that provides information to a user, a group of users, or a public, while adapting the information provided to conditions and events in the environment.

### SUMMARY OF THE INVENTION

The present invention overcomes the shortcomings of the conventional art and may achieve other advantages not contemplated by conventional devices.

According to a first aspect of the invention, a kiosk device comprises a plurality of input devices for acquiring a plurality of input signals, a memory device for storing a set of contents, a memory device for storing a plurality of rules, said rules linking input conditions and events to said set of contents, a processor device for treating said input signals and detecting conditions prevailing and events occurring in the environment of said kiosk device, and for determining from said conditions and events and on the basis of said set of rules, the contents to be provided.

According to the first aspect of the invention, a kiosk device is provided which has the capability to react autonomously and independently to events and conditions occurring in the environment. No explicit volition must be expressed by a user in order to adapt the information provided.

According to a second aspect of the invention, a method for adapting the information provided by a kiosk device comprises the steps of acquiring at least one of a plurality of signals, processing said signals for detecting conditions prevailing in the environment of said kiosk device, processing said signals for detecting events occurring in the environment of said kiosk device, determining from said conditions and events and on the basis of a set of rules the information to be provided by the kiosk device.

According to the second aspect, relevant output information is presented to people, depending of conditions in the environment, and behavior of people.

According to a third aspect of the invention, one or more computer-readable media have stored thereon a computer program for adapting the information provided by a kiosk device that, when executed by one or more processors, causes the one or more processors to: acquire at least one of a plurality of signals; process said signals for detecting conditions prevailing in the environment a kiosk device; process said signals for detecting events occurring in the environment of said kiosk device; determine from said conditions and events and on the basis of a set of rules the information to be provided by the kiosk device.

Other aspects and advantages of embodiments of the invention will be discussed with reference to the figures and to the detailed description of preferred embodiments.

### BRIEF DESCRIPTION OF THE DRAWING FIGURES

FIG. 1 is a schematic view of a kiosk device according to a typical embodiment of the invention, embedded in its environment.

FIG. 2 is a bloc diagram of a kiosk device according to the invention.

FIG. 3 is a dataflow diagram of the software embedded in the kiosk device according to the invention.

FIG. 4 is a schematic view of a kiosk device according to a specific embodiment of the invention, at a point of sales.

FIG. 5 is a schematic view of a kiosk device according to another specific embodiment of the invention, in a public exhibition.

### DETAILED DESCRIPTION

A kiosk device will be described below by way of preferred embodiments and with reference to the accompanying drawings.

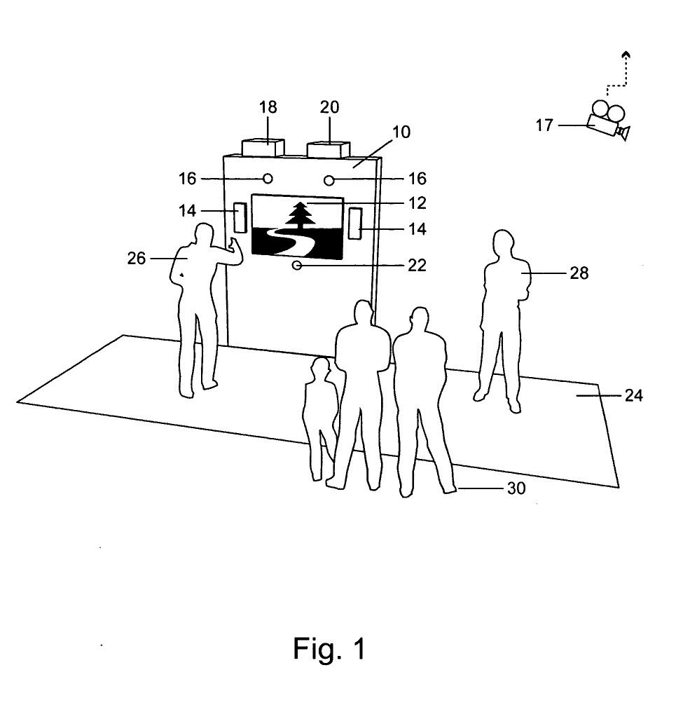

Referring to FIG. 1, a kiosk device 10, having a display device, 12, and a set of speakers 14 as output devices. The display device is preferably a large-size display, such as a plasma display panel. For street advertisements, the display panel may preferably be a LED panel, having a size as large as required by the application, e.g. 30 m wide by 10 m high, or even larger. A camera 16, preferably a stereoscopic camera, is mounted above the display device. An infra-red, ultrasound or radar sensor 20 may be mounted on the kiosk device. Optionally, an environmental sensor device 18 performs the function of acquiring other data: a digital weather station for acquiring weather conditions such as temperature, pressure, rainfall, a scanning device (e.g. to detect and read bar codes or specific images), a tag reader to detect tags (e.g. RadioFrequency tags) worn by people, a spectrum analyzer for detecting mobile phone traffic, or a sensor for wireless network protocols (bluetooth, GRPS, I-mode, IEEE 802.11 (also known as WiFi) . . . ), or other external cameras (including InfraRed cameras) to capture the people/crowd in the surroundings of the kiosk. Other specific sensors may be included in the kiosk device of the invention for special applications. For example, a computer nose to perform scent recognition may be included. Or (infrared) detectors to detect moving people may also be included. Or a hand palm sensor to capture pulse, pressure, temperature, electric activity of the user may also be included. A microphone 22 is installed as part of the kiosk device. Optionally, a pressure sensitive carpet 24 may be laid in front of the kiosk device. The output devices may comprise a display device 12 as shown on FIG. 1, but may in addition or alternatively comprise an animatronic figure or robot making gestures for conveying information to the public. The carpet 24 may also provide sensory feedback, e.g. vibrations. A smell generator may be provided for bringing the public, or a client, in a good mood.

It should be noted that in this embodiment, the kiosk device does not comprise a manual input device, such as a keyboard or a touch screen.

The camera 16 is arranged for capturing images of the scene in front of the kiosk device. Other cameras 17 may be arranged for capturing images of the scenes surrounding the kiosk device 10. The scene may comprise a static individual 26, an individual 28 moving in a direction, and/or a group or crowd 30 of static or moving individuals.

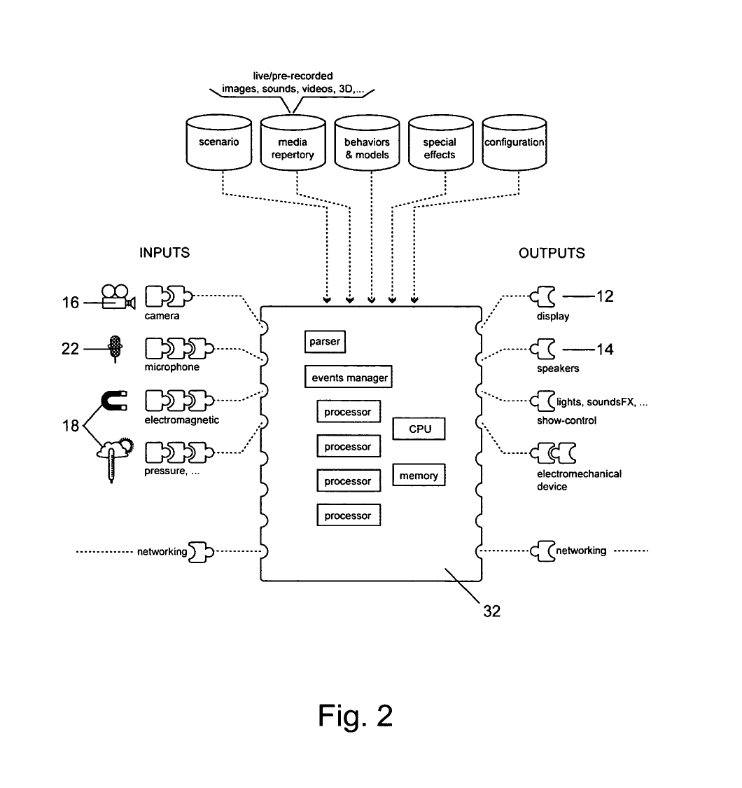

FIG. 2 is a bloc diagram of a typical embodiment of a kiosk device according to the invention. A set of sensors, comprising a dual stereoscopic digital camera 16, an environmental sensor 18 and a microphone 22, are connected to a processing device 32.

The processing device 32 may be a state-of-the-art PC. No processing power or capabilities is required beyond the one available from e.g. a Pentium 4, 2.2 GHz, 256 MB Ram.

The processing device 32 is programmed for treating the input signals and providing information to the public through display device 12. The processing device has access to a memory device storing a set of contents, e.g. scenarios, a media repertory storing live/pre-recorded images, sounds, videos, 3D images. The memory device also contains a set of rules defining behaviors and models, and special effects.

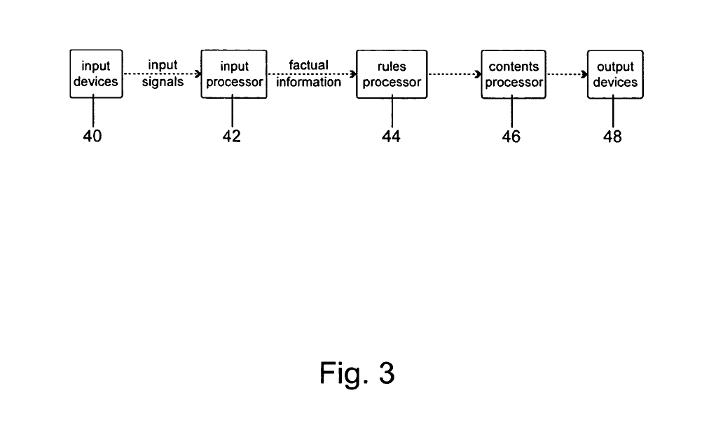

Referring to FIG. 3, the input devices 40 provide a set of input signals to the input processor 42. The input devices 40 may comprise an internal clock, a monoscopic digital video camera, a stereoscopic digital video camera, an IR camera, a near-IR radar or laser, a digital weather station giving weather conditions such as temperature, pressure, rainfall, a pressure sensitive carpet laid on the ground, a scanning device (e.g. to detect and read bar codes or specific images), a tag reader for detecting tags (e.g. Radio Frequency tags) worn by people, a radio-frequency spectrum analyzer, sensitive to mobile or wireless network protocols (bluetooth, GPRS, I-mode, IEEE 802.11 (also known as WiFi) . . . ), a microphone, a computer nose, detectors, a palm hand sensor.

The input processor 42 processes the input signals in order to provide factual information to a rules processor 44.

Based on the internal clock input, the input processor 42 may provide hour, day-of-week, conditions as to special holidays, etc.

Based on the microphone signal, the input processor 42 may evaluate the general loudness level and detect the presence of humans. A speech recognition module may recognize voice commands, in one or several languages.

The video signal is used to detect the presence of individuals and objects. By using a dual stereoscopic camera, a map of the distances of the various individuals and objects may be established. As an alternative, this map of distances may be obtained through an infrared device, an ultrasound system, or even radar. Known algorithms are used for detection of static individuals 26 or groups, or moving individuals 28 or groups 30. Processing device 32 comprises a software embodying these algorithms. Such known algorithms rely on a combination of change detection masks and motion estimation to detect individuals and crowds, texture analysis and neural network inferences to analyze the crowds, as well as other known signal processing techniques applied to (moving) images for depth estimation or motion analysis. These algorithms are discussed inter alia in the following publications:

T. W. S. Chow and Siu-Yeung Cho, Industrial neural vision system for underground railway station platform surveillance, Advanced Engineering Informatics, Volume 16, Issue 1, January 2002, Pages 73-83

T. W. S. Chow, J. Y. -F. Yam and S. -Y Cho, Fast training algorithm for feedforward neural networks: application to crowd estimation at underground stations, Artificial Intelligence in Engineering, Volume 13, Issue 3, July 1999, Pages 301-307

A. N. Marana, S. A. Velastin, L. F. Costa and R. A. Lotufo, Automatic estimation of crowd density using texture, Safety Science, Volume 28, Issue 3, April 1998, Pages 165-175

R. L. Hughes, The flow of large crowds of pedestrians, Mathematics and Computers in Simulation, Volume 53, Issues 4-6, 30 Oct. 2000, Pages 367-370

F. Vermaut, Y. Deville, X. Marichal and B. Macq, A Distributed Adaptive Block Matching Algorithm: Dis-ABMA, Signal Processing: Image Communication, 16, January 2001, pp. 431-444.

X. Marichal, On-line Web Application using Image Segmentation, WIAMIS'99, Berlin, May 1999, pp. 141-144.

Jun Ohya, Akira Utsumi, Junji Yamato, Analyzing Video Sequences of Multiple Humans—Tracking, Posture Estimation and Behavior Recognition, THE KLUWER INTERNATIONAL SERIES IN VIDEO COMPUTING Volume 3

Olivier Faugeras, Three-Dimensional Computer Vision: A Geometric Viewpoint, MIT Press, Cambridge, Mass., 1993.

The rules processor 44 uses the factual information provided by the input processor 42 for giving instructions to the contents processor 46.

The rules processor 44 decides what contents is to be shown on output devices 48, and when. It decides if a presentation is to be interrupted.

The rules processor is implemented as a set logic control structures, for example of multiple “IF . . . THEN . . . ELSE” structures:

```
IF (condition 1)
THEN (
    IF (condition 2)
    THEN
        Display Contents 1
    ELSE
        Display contents 2
```

Contents may comprise a video sequence to be displayed on the display device 12, and an audio sequence. These video and audio sequences may be stored sequences, or adapted depending on the conditions and events.

Contents can also comprise web pages, pictures, animated images, panoramic images, as well as more specific contents presented through proprietary viewers (Microsoft's PowerPoint, Macromedia Flash or Director . . . ).

The kiosk according to the invention may be installed in the entrance of a cinema, and display information to the public, according to what the public is most likely expecting. The kiosk may detect an entering crowd and, depending of the time of the day, display previews of the movies shown in the theaters during the next session. The kiosk may detect an outgoing crowd, and, depending on the time-of-day and weather conditions, provide information on restaurants having or not a terrace or for a covered shopping mall. The kiosk may detect a static individual 26 in front of the kiosk. The kiosk may then start a dialogue with said individual, with a synthesized speech, and instruct said individual to provide answers by body language (gestures), or voice. The kiosk may also try to catch the attention of a small group of individuals passing nearby and walking quietly by addressing them a message for offering information. In-between show times, the kiosk may display commercial ads: if mobile communications are detected, it may advertise the latest products for such communications, if high heels are detected on the carpet floor, it may advertise women fashion articles.

The kiosk device according to the invention has the capability to detect conditions and events occurring in its neighborhood, and to react to these conditions and events, in an independent way.

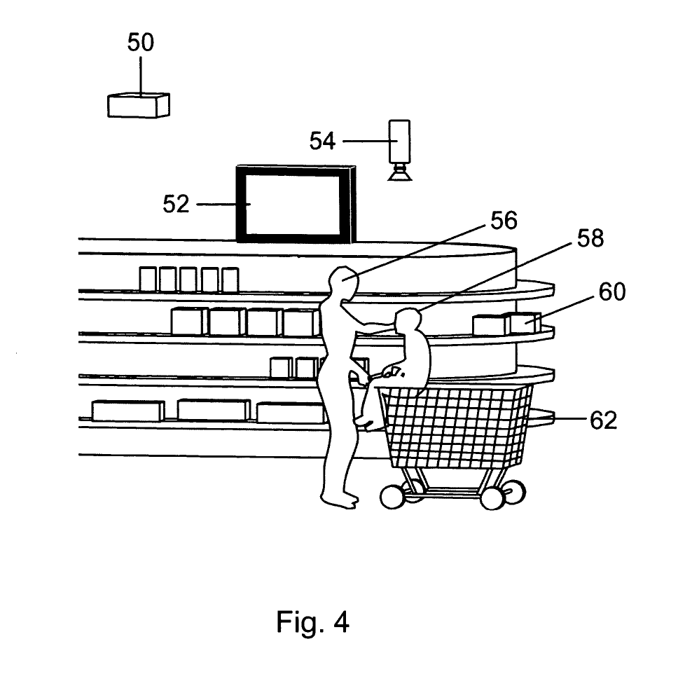

Referring to FIG. 4, a kiosk device embedded in a supermarket store is described. An adult 56 is walking in a supermarket department, with a shopping cart 62. The camera 54, in cooperation with an input processor 42 in a processing device 32 (not shown) is recognizing the behavior and the look of the adult 56, e.g. the presence of a child 58 on the cart 62. This factual information is forwarded to a rules processor 44 who decides to activate a sales scenario, and instructs a contents processor 46 to present a sales promotion or advertisement for a product 60 relevant to this context, e.g. the product 60 may be nappies. In addition, the kiosk device analyses the behavior of the adult 56 in response to the sales promotion, and collects valuable sales information. The kiosk device may then use its network connection to provide data to a central server. The data may comprise sales data or more detailed behavior analysis of the persons passing by for tuning the efficiency of a sales strategy. An outside weather station 50 may adapt the scenario to outside weather conditions.

The kiosk is preferably located in the middle of a corridor/alley, as shown on FIG. 4. Thereby, the flow of people is more easily detected and controlled. If a single person 56 is detected, the kiosk determines where this person is coming from and proposes a deal at the other end of the alley and vice-versa. If a group of customers passes by the kiosk, it signals its ability to help them by asking to approach and there is a specific scenario which is triggered according to the time, the day, the event, or the current sales action. The kiosk device may also be located at the end of an alley, where more people pass by.

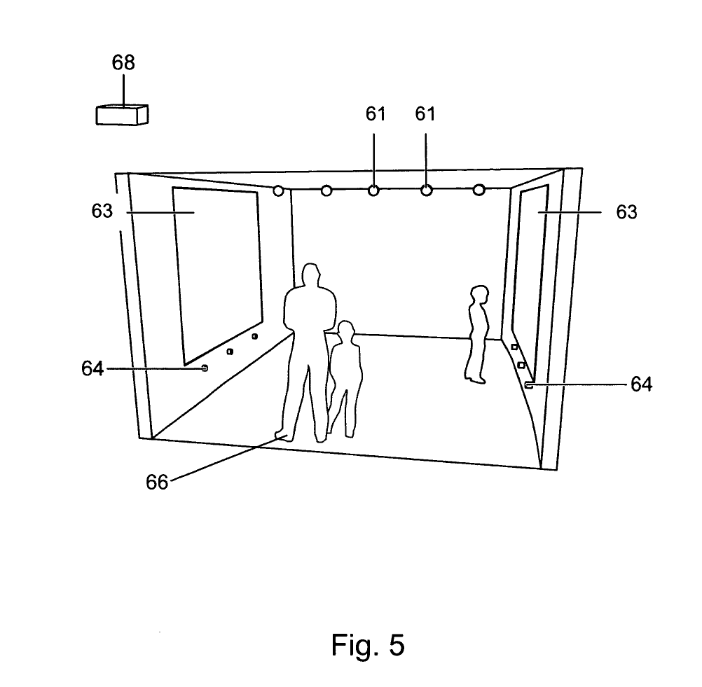

Another specific application of a kiosk device according to the invention is described with reference to FIG. 5. In this application, a “sensorial corridor”, a kiosk device is provided in an area where visitors pass by, e.g. in an exhibition. The kiosk device is provided with a simple set of input and output devices. The input devices may comprise a simple light barrier 64 actuated when a person 66 passes by. This event triggers the presentation of a scenery comprising the display of color slides on screens 63, and a lighting through lights 61, selected in dependence of the outdoor weather conditions detected by an outdoor weather station 68. Thereby, a mood is created, which corresponds to what is normally expected. Colors and slides remember the visitor of an outside morning sun or rainy day. This example shows that the kiosk device of the invention may be embodied in a very simple way, without having to rely on expensive input/output devices.

A kiosk may be helpful in any location where there is knowledge which can be conveyed without the fundamental need of human intervention: basic tourist information, promotional sales in stores, demos in lobbies for hotels and companies, flight self-registration, street advertizing and others.

The terms and descriptions used herein are set forth by way of illustration only and are not meant as limitations. Those skilled in the art will recognize that many variations are possible within the spirit and scope of the invention as defined in the following claims, and their equivalents, in which all terms are to be understood in their broadest possible sense unless otherwise indicated. In particular, constant evolution of the available processing power and speed allow for more exhaustive computations that provide more precise results and for new algorithms that best models reality in order to best interpret the environment.

What is claimed is:

1. A kiosk device comprising:
a plurality of input devices for acquiring a plurality of input signals;
a memory device for storing a set of contents;
a memory device for storing a plurality of rules, said rules linking input conditions and events to said set of contents;
a processor device for treating said input signals and detecting conditions prevailing and events occurring in the environment of said kiosk device, and for determining from said conditions and events, and on the basis of said set of rules, the contents to be provided; and
a plurality of output devices for providing said contents.

2. The kiosk device of claim 1, wherein the plurality of input devices comprises a camera for providing a video signal of an environment of said kiosk and said processor device comprises means for detecting individuals, groups of individuals, or movements of said individuals and groups of individuals.

3. The kiosk device of claim 2, wherein the plurality of rules comprises rules linking detected events and conditions related to individuals and groups of individuals to contents to be provided.

4. The kiosk device of claim 1, wherein the plurality of output devices is selected from the group consisting in a display device, a LED panel, a screen for displaying color slides, a robot or an animatronic, a speaker, a set of lights, a sensory feedback feedback device, and a smell generator.

5. The kiosk device of claim 1, wherein the plurality of input devices is selected from the group consisting in a monoscopic digital video camera, a stereoscopic digital video camera, an IR camera, a near-IR radar or laser, a digital weather station, a pressure sensitive carpet, a scanning device for detecting bar-codes or other specific images, a tag reader, a radio-frequency spectrum analyzer, a microphone, a computer nose, a palm hand sensor, a light barrier.

6. The kiosk device of claim 1, for use in a street advertisement, wherein the plurality of input devices comprises a digital weather station, and the plurality of output devices comprises a LED panel of large dimensions, whereby said contents may be adapted in dependence of said wheather conditions.

7. A method for adapting the information provided by a kiosk device, comprising:
acquiring at least one of a plurality of signals;
processing said signals for detecting conditions prevailing in the environment of said kiosk device;
processing said signals for detecting events occurring in the environment of said kiosk device;
determining from said conditions and events and on the basis of a set of rules the information to be provided by the kiosk device.

8. The method according to claim 7 wherein said plurality of signals comprises a video signal of an environment of said kiosk, and said processing for detecting events comprises detecting the appearances of an individual.

9. The method according to claim 7 wherein said plurality of signals comprises a video signal of an environment of said kiosk, and said processing for detecting events comprises detecting the movements of an individual.

10. The method according to claim 7 wherein said plurality of signals comprises a signal of an environment of said kiosk, and said processing for detecting events comprises detecting the appearances of a group of individuals.

11. The method according to claim 7 wherein said plurality of signals comprises a signal of an environment of said kiosk, and said processing for detecting events comprises detecting the movements of a group of individual.

12. The method according to claim 7 for use at a point of sale, comprising:
detecting the look and/or behavior of a person;
providing a sales promotion or advertisement in dependence of said look and or behavior.

13. The method according to claim 12 further comprising:
detecting the behavior of said person in response to said sales promotion or advertisement;
reporting said behavior to a central server.

14. The method according to claim 6 comprising:
detecting the passage of a person;
detecting outside weather conditions;
displaying a set of lights and/or a set of color images in dependence of said outside weather conditions.

15. One or more computer-readable media having stored thereon a computer program for adapting the information provided by a kiosk device that, when executed by one or more processors, causes the one or more processors to:
acquire at least one of a plurality of signals;
process said signals for detecting conditions prevailing in the environment a kiosk device;
process said signals for detecting events occurring in the environment of said kiosk device;
determine from said conditions and events and on the basis of a set of rules the information to be provided by the kiosk device.

16. One or more computer-readable media as claimed in claim 15 further comprising computer-readable data for images, sounds, videos, scenarios, and behavior rules.
